(19) United States
(12) Patent Application Publication
(10) Pub. No.: US 2024/0179584 A1
(43) Pub. Date: May 30, 2024

(54) METHOD AND DEVICE IN NODES USED FOR WIRELESS COMMUNICATION

(71) Applicants: Lin YANG, Shanghai (CN); Xiaobo ZHANG, Shanghai (CN)

(72) Inventors: Lin YANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/520,572

(22) Filed: Nov. 28, 2023

(30) Foreign Application Priority Data
Nov. 28, 2022 (CN) 202211499233.1

(51) Int. Cl. H04W 36/00; H04B 7/06

(52) U.S. Cl. CPC H04W 36/0058; H04B 7/0626; H04W 36/00835

(57) ABSTRACT

The present application discloses a method and a device in a node for wireless communications. A first receiver performs a first-type measurement on a first reference signal resource group of a first serving cell; and a second-type measurement on a second reference signal resource group of the first serving cell, where each of the first reference signal resource group and the second reference signal resource group respectively comprises at least one reference signal resource, of the at least one reference signal resource each reference signal resource being indicated by an SSB-Index. This application reduces the complexity of system implementation and enhances the performance.

### CROSS REFERENCE TO RELATED APPLICATIONS

This application claims the priority benefit of Chinese Patent Application No. 202211499233.1, filed on Nov. 28.2022, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

At present, new studies of 5G NR have begun in Release (R)-18, with network energy saving being one of its Study Items (SI), and techniques in terms of time domain, frequency domain, spatial domain and power domain are currently under study, where the power domain is seen as a key focus of study on network energy saving.

### SUMMARY

As provided in the existing standard, the transmit power of a Synchronization signal/Physical broadcast channel (SS/PBCH) Block (i.e., an SSB) is deemed constant. Inventors find through researches that for the sake of saving energy, the hypothesis above may be no longer established; furthermore, the purpose of the result of SSB-based measurement may also change.

To address the above problem, the present application provides a solution. It should be noted that the description in the present application only takes Uplink/Downlink as a typical application scenario; the present application also applies to other scenarios confronting similar issues, such as the Sidelink or V2X, in which similar technical effects can be achieved. Additionally, the adoption of a unified solution for various scenarios, including but not limited to multi-carrier scenarios, contributes to the reduction of hardcore complexity and costs. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict. Particularly, for interpretations of the terminology, nouns, functions and variables (unless otherwise specified) in the present application, refer to definitions given in TS36 series. TS37 series and TS38 series of 3GPP specifications.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
performing a first-type measurement on a first reference signal resource group of a first serving cell; and performing a second-type measurement on a second reference signal resource group of the first serving cell, where each of the first reference signal resource group and the second reference signal resource group respectively comprises at least one reference signal resource, of the at least one reference signal resource each reference signal resource being indicated by an SSB-Index;
herein, Energy per resource element (EPRE) in the first reference signal resource group is constant, and EPRE in the second reference signal resource group cannot be assumed to be identical to the EPRE in the first reference signal resource group; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

In one embodiment, the above method maintains favorable compatibility.

In one embodiment, the above method reduces the power overhead.

In one embodiment, the above method minimizes the influence on Legacy UE.

In one embodiment, the above method maintains a fixed cell coverage, or avoids frequent cell handovers.

According to one aspect of the present application, characterized in receiving a first signaling; herein, the first signaling comprises an ssb-PositionsInBurst, where all reference signal resources indicated by SSB-indexes corresponding to bits with a value of 1 in the ssb-PositionsInBurst in the first signaling form the first reference signal resource group.

In one embodiment, the above method enables the first serving cell to support a Legacy UE.

According to one aspect of the present application, characterized in receiving a second signaling; herein, the second signaling indicates an SSB-index of each reference signal resource in the second reference signal resource group.

According to one aspect of the present application, characterized in that the first-type measurement and the second-type measurement are respectively used for assessing the radio link quality and Non-L3 Cell Switch.

In one embodiment, the above method avoids unfairness due to inconsistent transmit powers.

In one embodiment, the above method avoids false alarm of link failure due to inconsistent transmit powers.

In one embodiment, the above method ensures the service quality.

According to one aspect of the present application, characterized in that the candidate purpose set comprises radio link monitoring.

According to one aspect of the present application, characterized in transmitting a first Channel State Information (CSI) report; herein, the first CSI report depends on the second-type measurement.

In one embodiment, the above method ensures timely feedback of the change of channel status.

According to one aspect of the present application, characterized in receiving a third signaling; herein, the third signaling is used to determine first time; for at least one reference signal resource in the second reference signal resource group. EPRE before the first time and after the first time cannot be deemed constant.

The present application provides a method in a second node for wireless communications, comprising:
transmitting a reference signal on a first reference signal resource group of a first serving cell, the first reference signal resource group being used for performing a first-type measurement; and transmitting a reference signal on a second reference signal resource group of the first serving cell, the second reference signal resource group being used for performing a second-type measurement; where each of the first reference signal resource group and the second reference signal resource group respectively comprises at least one reference signal resource, of the at least one reference signal resource each reference signal resource being indicated by an SSB-Index; herein, EPRE in the first reference signal resource group is constant, while EPRE in the second reference
signal resource group is variable; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

According to one aspect of the present application, characterized in transmitting a first signaling; herein, the first signaling comprises an ssb-PositionsInBurst, where all reference signal resources indicated by SSB-indexes corresponding to bits with a value of 1 in the ssb-PositionsInBurst in the first signaling form the first reference signal resource group.

According to one aspect of the present application, characterized in transmitting a second signaling; herein, the second signaling indicates an SSB-index of each reference signal resource in the second reference signal resource group.

According to one aspect of the present application, characterized in that the first-type measurement and the second-type measurement are respectively used for assessing the radio link quality and Non-L3 Cell Switch.

According to one aspect of the present application, characterized in that the candidate purpose set comprises radio link monitoring.

According to one aspect of the present application, characterized in receiving a first CSI report; herein, the first CSI report depends on the second-type measurement.

According to one aspect of the present application, characterized in transmitting a third signaling; herein, the third signaling is used to determine first time; for at least one reference signal resource in the second reference signal resource group. EPRE before the first time and after the first time is variable.

The present application provides a first node for wireless communications, comprising:
a first receiver, performing a first-type measurement on a first reference signal resource group of a first serving cell; and performing a second-type measurement on a second reference signal resource group of the first serving cell, where each of the first reference signal resource group and the second reference signal resource group respectively comprises at least one reference signal resource, of the at least one reference signal resource each reference signal resource being indicated by an SSB-Index;
herein, Energy per resource element (EPRE) in the first reference signal resource group is constant, and EPRE in the second reference signal resource group cannot be assumed to be identical to the EPRE in the first reference signal resource group; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

The present application provides a second node for wireless communications, comprising:
a second transmitter, transmitting a reference signal on a first reference signal resource group of a first serving cell, the first reference signal resource group being used for performing a first-type measurement; and transmitting a reference signal on a second reference signal resource group of the first serving cell, the second reference signal resource group being used for performing a second-type measurement; where each of the first reference signal resource group and the second reference signal resource group respectively comprises at least one reference signal resource, of the at least one reference signal resource each reference signal resource being indicated by an SSB-Index;
herein, EPRE in the first reference signal resource group is constant, while EPRE in the second reference signal resource group is variable; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of signal transmission according to one embodiment of the present application.

FIG. 6 illustrates a schematic diagram of a first-type measurement and a second-type measurement according to one embodiment of the present application.

FIG. 7 illustrates a schematic diagram of first time according to one embodiment of the present application.

FIG. 8 illustrates a schematic diagram illustrating beams of a first reference signal resource group and a second reference signal resource group according to one embodiment of the present application.

FIG. 9 illustrates a structure block diagram of a processing device used in a first node according to one embodiment of the present application.

FIG. 10 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

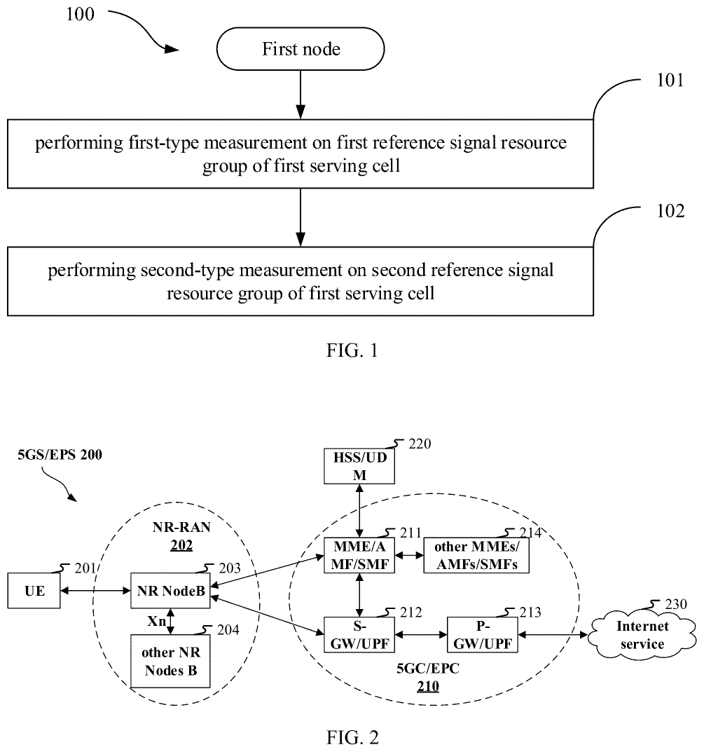

Embodiment 1 illustrates a flowchart of processing of a first node according to one embodiment of the present application, as shown in FIG. 1. In 100 illustrated by FIG. 1, each step represents a step, it should be particularly noted that the sequence order of each box herein does not imply a chronological order of steps marked respectively by these boxes.

In Embodiment 1, the first node in the present application performs a first-type measurement on a first reference signal resource group of a first serving cell in step 101; and performs a second-type measurement on a second reference signal resource group of the first serving cell; where each of the first reference signal resource group and the second reference signal resource group respectively comprises at least one reference signal resource, of the at least one reference signal resource each reference signal resource being indicated by an SSB-Index; herein. Energy per resource element (EPRE) in the first reference signal resource group is constant, and EPRE in the second reference signal resource group cannot be assumed to be identical to the EPRE in the first reference signal resource group; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

In one embodiment, the first serving cell is a Serving Cell of the first node.

In one embodiment, the first serving cell is a cell in a Cell group to which the first node belongs.

In one embodiment, the cell group to which the first node belongs is a Primary cell group (PCG).

In one embodiment, the cell group to which the first node belongs is a Secondary cell group (SCG).

In one embodiment, the first serving cell is a Primary cell (PCell).

In one embodiment, the first serving cell is a Primary secondary cell (PSCell).

In one embodiment, the first serving cell is a Secondary cell (SCell).

In one embodiment, the first reference signal resource group comprises the at least one reference signal resource.

In one embodiment, the at least one reference signal resource comprises multiple Synchronization signal/Physical broadcast channel (SS/PBCH) Blocks (SSBs).

In one embodiment, the at least one reference signal resource comprises no more than 64 SSBs.

In one embodiment, the at least one reference signal resource comprises no more than 8 SSBs.

In one embodiment, the at least one reference signal resource comprises no more than 4 SSBs.

In one embodiment, the at least one reference signal resource comprises only 1 SSB.

In one embodiment, any reference signal resource of the at least one reference signal resource comprises a Primary Synchronization Signal (PSS), a Secondary Synchronization Signal (SSS) and a PBCH.

In one embodiment, any reference signal resource of the at least one reference signal resource comprises a PSS, a SSS, a PBCH and a Demodulation reference signal (DMRS) of the PBCH.

In one embodiment, any reference signal resource of the at least one reference signal resource comprises a PSS, a SSS, and a Master Information Block (MIB).

In one embodiment, each reference signal resource of the at least one reference signal resource is indicated by an SSB-Index.

In one embodiment, each reference signal resource of the at least one reference signal resource corresponds to an SSB-Index.

In one embodiment, the SSB-Index is an integer.

In one embodiment, the SSB-Index is a non-negative integer.

In one embodiment, the SSB-Index is a non-negative integer no greater than 63.

In one embodiment, each reference signal in the at least one reference signal resource occurs periodically in time domain.

In one embodiment, each reference signal in the at least one reference signal resource occurs multiple times in time domain.

In one embodiment, each reference signal in the at least one reference signal resource occurs only once in time domain.

In one embodiment, a channel occupied by each reference signal in the at least one reference signal resource includes a PBCH.

In one embodiment, the second reference signal resource group comprises the at least one reference signal resource.

In one embodiment, the second reference signal resource group and the first reference signal resource group belong to a same cell.

In one embodiment, the second reference signal resource group and the first reference signal resource group belong to a same carrier.

In one embodiment, the second reference signal resource group and the first reference signal resource group belong to a same Bandwidth part (BWP).

In one embodiment, the second reference signal resource group and the first reference signal resource group are associated with a same initial DL BWP.

In one embodiment, a number of reference signal resources comprised by the second reference signal resource group is different from a number of reference signal resources comprised by the first reference signal resource group.

In one embodiment, a number of reference signal resources comprised by the second reference signal resource group is the same as a number of reference signal resources comprised by the first reference signal resource group.

In one embodiment, a sum of a number of reference signal resources comprised by the second reference signal resource group and a number of reference signal resources comprised by the first reference signal resource group is no greater than 64.

In one embodiment, a sum of a number of reference signal resources comprised by the second reference signal resource group and a number of reference signal resources comprised by the first reference signal resource group is greater than 64.

In one embodiment, a sum of a number of reference signal resources comprised by the second reference signal resource group and a number of reference signal resources comprised by the first reference signal resource group is no greater than 8.

In one embodiment, a sum of a number of reference signal resources comprised by the second reference signal resource group and a number of reference signal resources comprised by the first reference signal resource group is greater than 8.

In one embodiment, a sum of a number of reference signal resources comprised by the second reference signal resource group and a number of reference signal resources comprised by the first reference signal resource group is no greater than 4.

In one embodiment, a sum of a number of reference signal resources comprised by the second reference signal resource group and a number of reference signal resources comprised by the first reference signal resource group is greater than 4.

In one embodiment, the first-type measurement is an SSB-based measurement.

In one embodiment, the first-type measurement is an Intra-frequency measurement.

In one embodiment, the first-type measurement is an Inter-frequency measurement.

In one embodiment, the first-type measurement is an SSB-based Intra-frequency measurement.

In one embodiment, the first-type measurement is an SSB-based Inter-frequency measurement.

In one embodiment, the first-type measurement is used for RRC_CONNECTED state.

In one embodiment, the first-type measurement is used for RRC_INACTIVE state.

In one embodiment, the first-type measurement is used for RRC_IDLE state.

In one embodiment, the first-type measurement is used for obtaining a Reference Signal Received Power (RSRP).

In one embodiment, the first-type measurement is used for obtaining a Synchronization Signal Reference Signal Received Power (SS-RSRP).

In one embodiment, the first-type measurement is used for obtaining a Layer 1-RSRP (L1-RSRP).

In one embodiment, the first-type measurement is used for obtaining a Reference Signal Received Quality (RSRQ).

In one embodiment, the first-type measurement is used for obtaining a Synchronization Signal Reference Signal Received Quality (SS-RSRQ).

In one embodiment, the first-type measurement is used for obtaining a Signal-to-noise and interference ratio (SINR).

In one embodiment, the first-type measurement is used for obtaining a Synchronization signal signal-to-noise and interference ratio (SS-SINR).

In one embodiment, the first-type measurement is used for obtaining a L1-SINR.

In one embodiment, the first-type measurement is used for cell search.

In one embodiment, the first-type measurement is used for obtaining a Physical Cell Identity (PCI).

In one embodiment, the first-type measurement is used for synchronization in downlink.

In one embodiment, the first-type measurement is used for time-domain synchronization in downlink, the time-domain synchronization including frame synchronization, slot synchronization and symbol synchronization.

In one embodiment, the first-type measurement is used for frequency-domain synchronization in downlink.

In one embodiment, the first-type measurement is used for obtaining a MIB.

In one embodiment, the first-type measurement is used for obtaining system information (SI).

In one embodiment, the first-type measurement is used for obtaining a system information block 1 (SIB1).

In one embodiment, the first-type measurement is used for L3 Cell Handover.

In one embodiment, the L3 Cell Handover refers to cell switch that triggers Radio Resource Control (RRC) signaling.

In one embodiment, the RRC signaling is RRCReconfiguration.

In one embodiment, the L3 Cell Handover is Cell Level Mobility.

In one embodiment, the L3 Cell Handover includes inter-gNB switch.

In one embodiment, the L3 Cell Handover involves reconfiguration of a Medium Access Control entity.

In one embodiment, the L3 Cell Handover involves an occurrence of Radio Link Control (RLC) re-establishment.

In one embodiment, the L3 Cell Handover involves an occurrence of PDCP entity re-establishment.

In one embodiment, the L3 Cell Handover involves no occurrence of PDCP entity re-establishment.

In one embodiment, measurement resources of the first-type measurement include the first reference signal resource group.

In one embodiment, the first-type measurement is performed on one reference signal resource in the first reference signal resource group.

In one embodiment, the first-type measurement is performed on multiple reference signal resources in the first reference signal resource group.

In one embodiment, the second-type measurement is an SSB-based measurement.

In one embodiment, the second-type measurement is an Intra-frequency measurement.

In one embodiment, the second-type measurement is an Inter-frequency measurement.

In one embodiment, the second-type measurement is an SSB-based Intra-frequency measurement.

In one embodiment, the second-type measurement is an SSB-based Inter-frequency measurement.

In one embodiment, the second-type measurement is used for RRC_CONNECTED state.

In one embodiment, the second-type measurement is used for RRC_INACTIVE state.

In one embodiment, the second-type measurement is used for RRC_IDLE state.

In one embodiment, the second-type measurement is used for obtaining an RSRP.

In one embodiment, the second-type measurement is used for obtaining an SS-RSRP.

In one embodiment, the second-type measurement is used for obtaining a L1-RSRP.

In one embodiment, the second-type measurement is used for obtaining an RSRQ.

In one embodiment, the second-type measurement is used for obtaining an SS-RSRQ.

In one embodiment, the second-type measurement is used for obtaining a SINR.

In one embodiment, the second-type measurement is used for obtaining an SS-SINR.

In one embodiment, the second-type measurement is used for obtaining a L1-SINR.

In one embodiment, the second-type measurement is not used for cell search.

In one embodiment, the second-type measurement is not used for L3 Cell Handover.

In one embodiment, measurement resources of the second-type measurement include the second reference signal resource group.

In one embodiment, the second-type measurement is performed on one reference signal resource in the second reference signal resource group.

In one embodiment, the second-type measurement is performed on multiple reference signal resources in the second reference signal resource group.

In one embodiment, the second reference signal resource group is different from the first reference signal resource group.

In one embodiment, any reference signal resource in the second reference signal resource group is different from any reference signal resource in the first reference signal resource group.

In one embodiment of the first-type measurement and the second-type measurement only the first-type measurement is used for the first purpose, the first purpose being any purpose in the candidate purpose set.

In one embodiment, the candidate purpose set comprises at least one of Cell Search or Layer3 (L3) Cell Handover.

In one embodiment, the candidate purpose set comprises radio link monitoring.

In one embodiment, the candidate purpose set comprises link recovery.

In one embodiment, the candidate purpose set comprises detecting beam failure.

In one embodiment, the candidate purpose set comprises beam failure recovery.

In one embodiment, EPRE in any reference signal resource in the first reference signal resource group is deemed constant.

In one embodiment, EPREs in any two reference signal resources in the first reference signal resource group are deemed constant.

In one embodiment, EPREs in all reference signal resources in the first reference signal resource group are deemed constant.

In one embodiment, for any reference signal resource in the first reference signal resource group, EPREs in different slots are deemed constant.

In one embodiment, for any reference signal resource in the first reference signal resource group. EPREs in different BWPs are deemed constant.

In one embodiment, for any reference signal resource in the first reference signal resource group. EPRES in a same BWP are deemed constant.

In one embodiment, the EPRE is decided by a gNB.

In one embodiment, the EPRE is measured in dBm.

In one embodiment, the EPRE is a downlink EPRE.

In one embodiment, the EPRE is an SSB-linked EPRE.

In one embodiment, the EPRE is an SSS EPRE.

In one embodiment, the EPRE is a PBCH DMRS EPRE.

In one embodiment, a ratio of the SSS EPRE to the PBCH DMRS EPRE is 0 dB.

In one embodiment, the EPRE depends on a transmit power of SSS.

In one embodiment, the transmit power of SSS is configured by a higher-layer parameter ss-PBCH-BlockPower.

In one embodiment, the transmit power of SSS refers to a linear average of powers of all SSS-bearing resource elements (REs).

In one embodiment, EPREs in any two reference signal resources in the second reference signal resource group cannot be deemed constant.

In one embodiment, EPRE in any reference signal resource in the second reference signal resource group is constant.

In one embodiment, EPRE in any reference signal resource in the second reference signal resource group cannot be deemed constant.

In one embodiment, EPRE in each reference signal resource in the second reference signal resource group cannot be deemed constant.

In one embodiment, for any reference signal resource in the second reference signal resource group. EPRES in different slots cannot be deemed constant.

In one embodiment, for any reference signal resource in the second reference signal resource group. EPREs in different periods cannot be deemed constant, the periods including a period of SSB.

In one embodiment, EPRE in any reference signal resource in the second reference signal resource group cannot be assumed to be identical to EPRE in any reference signal resource in the first reference signal resource group.

In one embodiment, within a same slot. EPRE in any reference signal resource in the second reference signal resource group cannot be assumed to be identical to EPRE in any reference signal resource in the first reference signal resource group.

In one embodiment, within different slots. EPRE in any reference signal resource in the second reference signal resource group cannot be assumed to be identical to EPRE in any reference signal resource in the first reference signal resource group.

In one embodiment, within a same period. EPRE in any reference signal resource in the second reference signal resource group cannot be assumed to be identical to EPRE in any reference signal resource in the first reference signal resource group, the periods including a period of SSB.

In one embodiment, within different periods. EPRE in any reference signal resource in the second reference signal resource group cannot be assumed to be identical to EPRE in any reference signal resource in the first reference signal resource group, the periods including a period of SSB.

### Embodiment 2

Embodiment 2 illustrates a schematic diagram of a network architecture according to one embodiment of the present application, as shown in FIG. 2. FIG. 2 is a diagram illustrating a network architecture 200 of 5G New Radio (NR)/Long-Term Evolution (LTE)/Long-Term Evolution Advanced (LTE-A) system. The 5G NR/LTE/LTE-A network architecture 200 may be called 5G System/Evolved Packet System (5GS/EPS) 200 or other appropriate terms. The 5GS/EPS 200 may comprise one or more UEs 201, a RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The RAN comprises a node 203 and other nodes 204. The node 203 provides UE 201 oriented user plane and control plane terminations. The node 203 can be connected to other nodes 204 via an Xn interface (like backhaul)/X2 interface. The node 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The node 203 provides an access point to the 5GC/EPC210 for the UE201. Examples of UE 201 include cellular phones, smart phones. Session Initiation Protocol (SIP) phones, laptop computers. Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The node 203 is connected to 5GC/EPC210 via a S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF211 is a control node for processing signaling between the UE201 and the 5GC/EPC210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet. Intranet. IP Multimedia Subsystem (IMS) and Packet Switching Streaming (PSS) services.

In one embodiment, the UE 201 corresponds to the first node in the present application.

In one embodiment, the UE 201 is a UE.

In one embodiment, the UE 201 is an ender.

In one embodiment, the node 203 corresponds to the second node in the present application.

In one embodiment, the node 203 is a BaseStation (BS).

In one embodiment, the node 203 is a Base Transceiver Station (BTS).

In one embodiment, the node 203 is a NodeB (NB).

In one embodiment, the node 203 is a gNB.

In one embodiment, the node 203 is an eNB.

In one embodiment, the node 203 is a ng-eNB.

In one embodiment, the node 203 is an en-gNB.

In one embodiment, the node 203 comprises at least one TRP.

In one embodiment, the UE supports transmissions in Non-Terrestrial Network (NTN).

In one embodiment, the UE supports transmissions in Terrestrial Network.

In one embodiment, the UE supports NR.

In one embodiment, the UE supports UTRA.

In one embodiment, the UE supports EUTRA.

In one embodiment, the base station supports transmissions in NTN.

In one embodiment, the base station supports transmissions in TN.

In one embodiment, the base station comprises a MacroCellular base station.

In one embodiment, the base station comprises a Micro Cell base station.

In one embodiment, the base station comprises a Pico Cell base station.

In one embodiment, the base station comprises a Femtocell.

In one embodiment, the base station comprises a flight platform.

In one embodiment, the base station comprises satellite equipment.

In one embodiment, the base station comprises a Transmitter Receiver Point (TRP).

In one embodiment, the base station comprises a Centralized Unit (CU).

In one embodiment, the base station comprises a Distributed Unit (DU).

In one embodiment, a radio link from the UE201 to the gNB203 is an uplink, the uplink being used for performing uplink transmission.

In one embodiment, a radio link from the gNB203 to the UE201 is a downlink, the downlink being used for performing downlink transmission.

In one embodiment, the UE201 and the gNB203 are connected by a Uu air interface.

### Embodiment 3

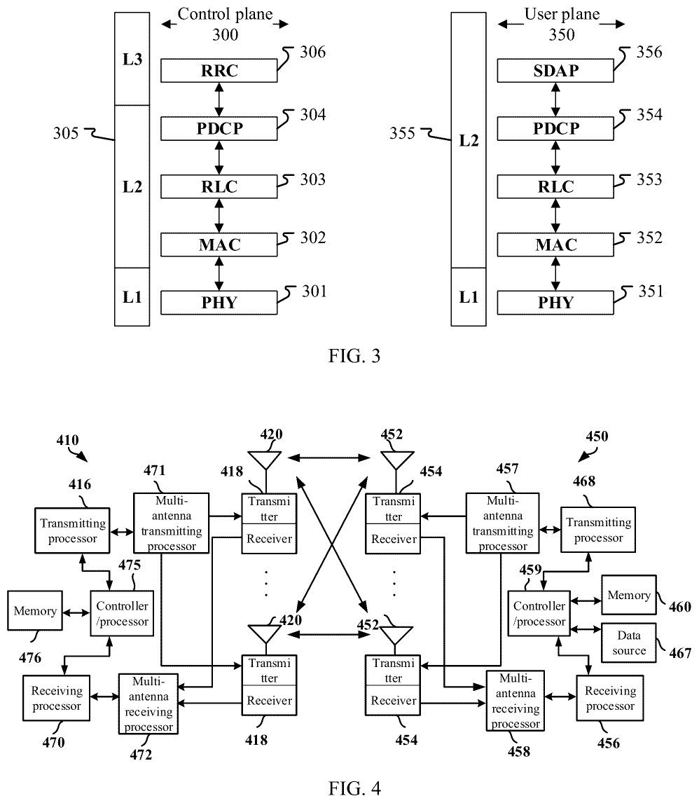

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 of a UE and a gNB is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the UE and the gNB via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection, and also support for handover of a UE between gNBs. The RLC sublayer 303 provides segmentation and reassembling of a packet, retransmission of a lost packet through an Automatic Repeat Request (ARQ), and detection of duplicate packets and protocol errors. The MAC sublayer 302 provides mappings between a logical channel and a transport channel as well as multiplexing of logical channels. The MAC sublayer 302 is also responsible for allocating between UEs various radio resources (i.e., resource block) in a cell. The MAC sublayer 302 is also in charge of Hybrid Automatic Repeat Request (HARQ) operation. In the control plane 300. The Radio Resource Control (RRC) sublayer 306 in the L3 layer is responsible for acquiring radio resources (i.e., radio bearer) and configuring the lower layer using an RRC signaling between the gNB and the UE. The radio protocol architecture in the user plane 350 comprises the L1 layer and the L2 layer. In the user plane 350, the radio protocol architecture used for a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between Quality of Service (QOS) streams and a Data Radio Bearer (DRB), so as to support diversified traffics. The radio protocol architecture of UE in the user plane 350 may comprise all or part of protocol sublayers of a SDAP sublayer 356, a PDCP sublayer 354, a RLC sublayer 353 and a MAC sublayer 352 in L2. Although not described in FIG. 3, the UE may comprise several higher layers above the L2 355, such as a network layer (i.e., IP layer) terminated at a P-GW of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC306.

In one embodiment, the second signaling in the present application is generated by the RRC306.

In one embodiment, the third signaling in the present application is generated by the MAC302 or the MAC352.

In one embodiment, the third signaling in the present application is generated by the PHY301 or the PHY351.

In one embodiment, the L2 305 or 355 belongs to a higher layer.

In one embodiment, the RRC sublayer 306 in the L3 belongs to a higher layer.

### Embodiment 4

Embodiment 4 illustrates a schematic diagram of a first communication device and a second communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of HARQ operation, a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping of signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication node 450 comprises at least one processor and at least one memory; the at least one memory comprises computer program codes; the at least one memory and the computer program codes are configured to be used in collaboration with the at least one processor, the first communication device 450 at least: performs a first-type measurement on a first reference signal resource group of a first serving cell; and performs a second-type measurement on a second reference signal resource group of the first serving cell, where each of the first reference signal resource group and the second reference signal resource group respectively comprises at least one reference signal resource, of the at least one reference signal resource each reference signal resource being indicated by an SSB-Index; herein. Energy per resource element (EPRE) in the first reference signal resource group is constant, and EPRE in the second reference signal resource group cannot be assumed to be identical to the EPRE in the first reference signal resource group; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

In one embodiment, the first communication node 450 comprises a memory that stores a computer readable instruction program, the computer readable instruction program generates actions when executed by at least one processor, which include: performing a first-type measurement on a first reference signal resource group of a first serving cell; and performing a second-type measurement on a second reference signal resource group of the first serving cell, where each of the first reference signal resource group and the second reference signal resource group respectively comprises at least one reference signal resource, of the at least one reference signal resource each reference signal resource being indicated by an SSB-Index; herein. Energy per resource element (EPRE) in the first reference signal resource group is constant, and EPRE in the second reference signal resource group cannot be assumed to be identical to the EPRE in the first reference signal resource group; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

In one embodiment, the second communication node 410 comprises at least one processor and at least one memory, the at least one memory comprises computer program codes; the at least one memory and the computer program codes are configured to be used in collaboration with the at least one processor. The second communication device 410 at least: transmits a reference signal on a first reference signal resource group of a first serving cell, the first reference signal resource group being used for performing a first-type measurement; and transmits a reference signal on a second reference signal resource group of the first serving cell, the second reference signal resource group being used for performing a second-type measurement; where each of the first reference signal resource group and the second reference signal resource group respectively comprises at least one reference signal resource, of the at least one reference signal resource each reference signal resource being indicated by an SSB-Index; herein, EPRE in the first reference signal resource group is constant, while EPRE in the second reference signal resource group is variable; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

In one embodiment, the second communication node 410 comprises a memory that stores a computer readable instruction program, the computer readable instruction program generates actions when executed by at least one processor, which include: transmitting a reference signal on a first reference signal resource group of a first serving cell, the first reference signal resource group being used for performing a first-type measurement; and transmitting a reference signal on a second reference signal resource group of the first serving cell, the second reference signal resource group being used for performing a second-type measurement; where each of the first reference signal resource group and the second reference signal resource group respectively comprises at least one reference signal resource, of the at least one reference signal resource each reference signal resource being indicated by an SSB-Index; herein. EPRE in the first reference signal resource group is constant, while EPRE in the second reference signal resource group is variable; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

In one embodiment, the antenna 452, the receiver 454, the receiving processor 456, and the controller/processor 459 are used for receiving a first signaling; at least one of the antenna 420, the transmitter 418, the transmitting processor 416 or the controller/processor 475 is used for transmitting a first signaling.

In one embodiment, at least one of the antenna 452, the receiver 454, the receiving processor 456, the multi-antenna receiving processor 458, the controller/processor 459, the memory 460 or the data source 467 is used to receive the first signaling in the present application; at least one of the antenna 420, the transmitter 418, the transmitting processor 416, the multi-antenna transmitting processor 471, the controller/processor 475 or the memory 476 is used to transmit the first signaling in the present application.

In one embodiment, at least one of the antenna 452, the receiver 454, the receiving processor 456, the multi-antenna receiving processor 458, the controller/processor 459, the memory 460 or the data source 467 is used to receive the second signaling in the present application; at least one of the antenna 420, the transmitter 418, the transmitting processor 416, the multi-antenna transmitting processor 471, the controller/processor 475 or the memory 476 is used to transmit the second signaling in the present application.

In one embodiment, at least one of the antenna 452, the receiver 454, the receiving processor 456, the multi-antenna receiving processor 458, the controller/processor 459, the memory 460 or the data source 467 is used to receive the third signaling in the present application; at least one of the antenna 420, the transmitter 418, the transmitting processor 416, the multi-antenna transmitting processor 471, the controller/processor 475 or the memory 476 is used to transmit the third signaling in the present application.

In one embodiment, the first communication device 450 corresponds to the first node in the present application.

In one embodiment, the second communication device 410 corresponds to the second node in the present application.

In one embodiment, the first communication device 450 is a UE.

In one embodiment, the second communication device 410 is a base station (gNB/eNB/ng-eNB).

### Embodiment 5

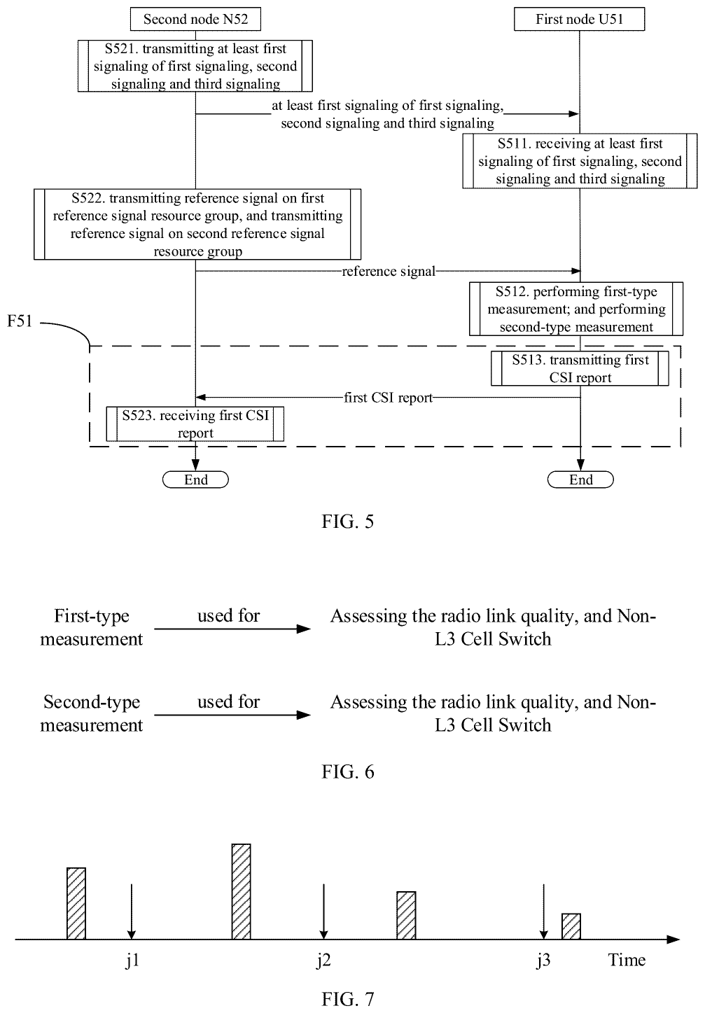

Embodiment 5 illustrates a flowchart of signal transmission according to one embodiment of the present application, as shown in FIG. 5. In FIG. 5, a first node U51 and a second node N52 are respectively two communication nodes that transmit via an air interface. It should be particularly noted that the sequence illustrated herein does not set any limit to the signal transmission order or implementation order in the present application.

The first node U51 receives at least a first signaling of a first signaling, a second signaling and a third signaling in step S511; and performs a first-type measurement, and a second-type measurement in step S512; and transmits a first CSI report in step S513.

The second node N52 transmits at least the first signaling of the first signaling, the second signaling and the third signaling in step S521; and transmits a reference signal on a first reference signal resource group, and transmits a reference signal on a second reference signal resource group in step S522; and receives a first CSI report in step S523.

In Embodiment 5, the first signaling comprises an ssb-PositionsInBurst, where all reference signal resources indicated by SSB-indexes corresponding to bits with a value of 1 in the ssb-PositionsInBurst in the first signaling form the first reference signal resource group; the second signaling indicates an SSB-index of each reference signal resource in the second reference signal resource group; the first CSI report depends on the second-type measurement.

In one embodiment, steps marked by the dotted-line box F51 are optional.

In one embodiment, steps marked by the dotted-line box F51 exist.

In one embodiment, steps marked by the dotted-line box F51 do not exist.

In one embodiment, the first signaling is a higher-layer signaling.

In one embodiment, the first signaling is a higher-layer signaling specific to the first serving cell of the first node.

In one embodiment, the first signaling comprises one or more fields in an RRC information element (IE).

In one embodiment, the first signaling is a field in a SIB1.

In one embodiment, the first signaling is a field in ReconfigurationWithSync.

In one embodiment, the first signaling is a field in SCellConfig.

In one embodiment, the first signaling is a ServingCellConfigCommon IE.

In one embodiment, the first signaling comprises one or more fields in a ServingCellConfigCommon IE.

In one embodiment, the first signaling is a ServingCellConfigCommonSIB IE.

In one embodiment, the first signaling comprises one or more fields in a ServingCellConfigCommonSIB IE.

In one embodiment, the first signaling comprises a ssb-PositionsInBurst.

In one embodiment, the ssb-PositionsInBurst in the first signaling is a bitmap.

In one embodiment, the ssb-PositionsInBurst in the first signaling is a bitmap with a length of 4.

In one embodiment, the ssb-PositionsInBurst in the first signaling is a bitmap with a length of 8.

In one embodiment, the ssb-PositionsInBurst in the first signaling is a bitmap with a length of 64.

In one embodiment, each bit in the ssb-PositionsInBurst in the first signaling corresponds to an SSB-index.

In one embodiment, all reference signal resources indicated by SSB-indexes corresponding to bits with a value of 1 in the ssb-PositionsInBurst in the first signaling form the first reference signal resource group.

In one embodiment, reference signal resources indicated by SSB-indexes corresponding to partial bits with a value of 1 in the ssb-PositionsInBurst in the first signaling form the first reference signal resource group.

In one embodiment, none of reference signal resources indicated by SSB-indexes corresponding to bits with a value of 0) in the ssb-PositionsInBurst in the first signaling belongs to the first reference signal resource group.

In one embodiment, none of reference signal resources indicated by SSB-indexes corresponding to bits with a value of 0 in the ssb-PositionsInBurst in the first signaling is any reference signal resource in the first reference signal resource group.

In one embodiment, the first signaling is supported by UEs before Release 18.

In one embodiment, the first signaling is UE-specific.

In one embodiment, the first signaling is used for configuring a UE group specific parameter, where the first node is a UE in the UE group.

In one embodiment, the UE group comprises UEs that only support Release 17 and previous Releases.

In one embodiment, the UE group comprises UEs that support Release 18 and following Releases.

In one embodiment, the first signaling is used for configuring a cell-specific parameter.

In one embodiment, the second signaling is a higher-layer signaling.

In one embodiment, the second signaling is a higher-layer signaling specific to the first serving cell of the first node.

In one embodiment, the second signaling comprises one or more fields in an RRC IE.

In one embodiment, the second signaling comprises one or more fields in a ServingCellConfigCommon IE.

In one embodiment, the second signaling comprises one or more fields in a ServingCellConfigCommonSIB IE.

In one embodiment, the second signaling comprises one or more fields in a RadioLinkMonitoringConfig IE.

In one embodiment, the second signaling is a ssb-PositionsInBurst.

In one embodiment, bits with a value of 0 in the ssb-PositionsInBurst respectively indicate an SSB-index of each reference signal resource in the second reference signal resource group.

In one embodiment, all reference signal resources indicated by SSB-indexes corresponding to bits with a value of 0 in the ssb-PositionsInBurst form the second reference signal resource group.

In one embodiment, the second signaling is a failureDetectionResourcesToAddModList.

In one subembodiment, the failureDetectionResourcesToAddModList comprises at least one RadioLinkMonitoringRS.

In one subembodiment, an SSB-Index in the at least one RadioLinkMonitoringRS comprised by the failureDetectionResourcesToAddModList indicates each reference signal resource in the second reference signal resource group.

In one subembodiment, an SSB-Index in the at least one RadioLinkMonitoringRS comprised by the failureDetectionResourcesToAddModList indicates part of reference signal resources in the second reference signal resource group.

In one embodiment, the second signaling comprises multiple bits, of which each bit corresponds to one SSB-index, and all reference signal resources indicated by SSB-indexes corresponding to bits with a value of 1 among the multiple bits form the second reference signal resource group.

In one embodiment, a number of bits among the multiple bits is one of 4, 8 or 64.

In one embodiment, any bit among the multiple bits cannot indicate any reference signal resource in the first reference signal resource group.

In one embodiment, a number of bits among the multiple bits is a number of bits with a value of 0 in the ssb-PositionsInBurst in the first signaling.

In one embodiment, the multiple bits correspond to SSB-indexes indicated by bits with a value of 0 in the ssb-PositionsInBurst in the first signaling.

In one embodiment, the second signaling is not supported by UEs of releases before Release 18.

In one embodiment, the second signaling is UE-specific.

In one embodiment, the second signaling is used for configuring a cell-specific parameter.

In one embodiment, the second signaling is used for configuring a UE group specific parameter, where the first node is a UE in the UE group.

In one embodiment, the UE group does not comprise UEs that only support Release 17 and previous Releases.

In one embodiment, CSI-ReportConfig is used for configuring the first CSI report.

In one embodiment, csi-IM-ResourcesForInterference in the CSI-ReportConfig is used for configuring a CSI-IM resource.

In one embodiment, nzp-CSI-RS-ResourcesForInterference in the CSI-ReportConfig is used for configuring a CSI-RS resource.

In one embodiment, resourcesForChannelMeasurement in the CSI-ReportConfig is used for configuring a CSI-RS resource or an SSB resource.

In one embodiment, a reference signal resource configured by resourcesForChannelMeasurement in the CSI-ReportConfig belongs to the second reference signal resource group.

In one embodiment, contents comprised by the first CSI report are indicated by reportQuantity in the CSI-reportconfig.

In one embodiment, the first CSI report comprises at least one of a CSI-RS Resource Indicator (CRI), a Rank Indicator (RI), a Precoding Matrix Indicator (PMI) or a Channel quality indicator (CQI).

In one embodiment, the first CSI report comprises a Layer Indicator (LI).

In one embodiment, the first CSI report comprises a Reference Signal Receiving Power (RSRP).

In one embodiment, the second-type measurement performed on the second reference signal resource group is used for generating the first CSI report.

In one embodiment, the second-type measurement performed on at least one reference signal resource in the second reference signal resource group is used for generating the first CSI report.

In one embodiment, a report type of the first CSI report is indicated by a reportConfigType field in the CSI-reportconfig.

In one embodiment, the reportConfigType field in the CSI-ReportConfig is semiPersistentOnPUCCH.

In one embodiment, the reportConfigType field in the CSI-ReportConfig is semiPersistentOnPUSCH.

In one embodiment, the reportConfigType field in the CSI-ReportConfig is periodic.

In one embodiment, the reportConfigType field in the CSI-ReportConfig is aperiodic.

In one embodiment, the second-type measurement is used for channel measurement.

In one embodiment, the second-type measurement is used for interference measurement.

In one embodiment, the first CSI report depends on a first channel measurement and a first interference measurement, and the first channel measurement depends on the second-type measurement.

In one embodiment, at least one reference signal resource in the second reference signal resource group is configured for the first channel measurement.

In one embodiment, at least one reference signal resource in the second reference signal resource group is configured for the first interference measurement.

In one embodiment, a first reference signal resource is configured for the first channel measurement, and at least one reference signal resource in the second reference signal resource group is used to determine a Rx spatial filter of the first reference signal resource, the first reference signal resource being a CSI-RS resource.

In one embodiment, the first reference signal resource is configured for the first channel measurement, the first reference signal resource being a reference signal resource in the second reference signal resource group, and the first reference signal resource being an SSB.

In one embodiment, the meaning of the phrase that the first CSI report depends on the second-type measurement includes: a CSI-IM resource or CSI-RS resource configured by the CSI-ReportConfig has a Quasi co-location (QCL) relation with the second reference signal resource group.

In one embodiment, the meaning of the phrase that the first CSI report depends on the second-type measurement includes: a CSI-IM resource or CSI-RS resource configured by the CSI-ReportConfig has a QCL relation with a reference signal resource in the second reference signal resource group.

In one embodiment, the meaning of the phrase that the first CSI report depends on the second-type measurement includes: a CSI-IM resource or CSI-RS resource configured by the CSI-ReportConfig has a QCL relation with multiple reference signal resources in the second reference signal resource group.

In one embodiment, the meaning of the phrase that the first CSI report depends on the second-type measurement includes: an SSB resource configured by the CSI-ReportConfig belongs to the second reference signal resource group.

In one embodiment, the meaning of the phrase that the first CSI report depends on the second-type measurement includes: an SSB resource configured by the CSI-ReportConfig is a reference signal resource in the second reference signal resource group.

In one embodiment, a Transmission configuration indication (TCI) state indicates a QCL relation.

In one embodiment, a TCI state indicates one or more reference signal resources.

In one embodiment, a TCI state indicates at least one reference signal resource.

In one embodiment, any reference signal resource indicated by a TCI state is one of a Sounding Reference Signal (SRS) resource, a CSI-RS resource or a SSB resource.

In one embodiment, a TCI state indicates at least one reference signal resource and a QCL parameter corresponding to each of the at least one reference signal resource.

In one embodiment, a TCI state indicates at least one reference signal resource and a type of a QCL parameter corresponding to each of the at least one reference signal resource.

In one embodiment, the type of the QCL parameter includes TypeA, TypeB, TypeC and TypeD.

In one embodiment, a QCL parameter of TypeA includes a Doppler shift, a Doppler spread, an average delay, and a delay spread.

In one embodiment, a QCL parameter of TypeB includes a Doppler shift and a Doppler spread.

In one embodiment, a QCL parameter of TypeC includes a Doppler shift and an average delay.

In one embodiment, a QCL parameter of TypeD includes a Spatial Rx parameter.

In one embodiment, the QCL parameter includes one or more of a delay spread, a Doppler spread, a Doppler shift, an average delay, or a Spatial Rx parameter.

In one embodiment, the QCL parameter includes a Doppler shift and a Doppler spread.

In one embodiment, the QCL parameter includes a Doppler shift and an average delay.

In one embodiment, the QCL parameter includes a Spatial Rx parameter.

In one embodiment, the QCL parameter includes at least one of a Spatial Tx parameter or a Spatial Rx parameter.

In one embodiment, for the specific definitions of TCI state and QCL, refer to 3GPP TS38.214. Section 5.1.5.

### Embodiment 6

Embodiment 6 illustrates a schematic diagram of a first-type measurement and a second-type measurement according to one embodiment of the present application, as shown in FIG. 6.

In Embodiment 6, the first-type measurement and the second-type measurement are respectively used for assessing the radio link quality and Non-L3 Cell Switch.

In one embodiment, the phrase “assessing the radio link quality” is used for radio link monitoring.

In one embodiment, the phrase “assessing the radio link quality” is used for link recovery.

In one embodiment, the phrase “assessing the radio link quality” is used for detecting beam failure.

In one embodiment, the phrase “assessing the radio link quality” is used for beam failure recovery.

In one embodiment, the first-type measurement is performed on an active downlink BWP.

In one embodiment, the first-type measurement is used for obtaining multiple block error rates (BLERs).

In one embodiment, any BLER of the multiple BLERs obtained by the first-type measurement is greater than Q_{in.}

In one embodiment, each BLER of the multiple BLERs obtained by the first-type measurement is less than Q_{out.}

In one embodiment, the Qᵢₙ and the Qₒᵤₜ are configured by a rlmInSyncOutOfSyncThreshold.

In one embodiment, the rlmInSyncOutOfSyncThreshold is a higher layer parameter.

In one embodiment, the second-type measurement is performed on an active downlink BWP.

In one embodiment, the second-type measurement is used for obtaining multiple BLERs.

In one embodiment, any BLER of the multiple BLERs obtained by the second-type measurement is greater than Q_{in.}

In one embodiment, each BLER of the multiple BLERs obtained by the second-type measurement is less than Q_{out.}

In one embodiment, the phrase “assessing the radio link quality” yields a result of in-sync.

In one embodiment, the phrase “assessing the radio link quality” yields a result of out-of-sync.

In one embodiment, assessing the radio link quality is performed once per indication period.

In one embodiment, the indication period is a maximum value between a smallest period of reference signal resources used for performing the first-type measurement and 10 ms.

In one embodiment, the indication period is a maximum value between a smallest period of reference signal resources used for performing the first-type measurement and a Discontinuous reception (DRX) period.

In one embodiment, the indication period is a maximum value between a smallest period of reference signal resources used for performing the second-type measurement and 10 ms.

In one embodiment, the indication period is a maximum value between a smallest period of reference signal resources used for performing the second-type measurement and a DRX period.

In one embodiment, the indication period is a smallest period of reference signal resources used for performing the first-type measurement.

In one embodiment, the indication period is a smallest period of reference signal resources used for performing the second-type measurement.

In one embodiment, the indication period is a DRX period.

In one embodiment, the indication period is 10 ms.

In one embodiment, the non-L3 cell switch does not trigger RRC signaling.

In one embodiment, the RRC signaling is RRCReconfiguration.

In one embodiment, triggering of the non-L3 cell switch is based on a Layer (L1) signaling.

In one embodiment, triggering of the non-L3 cell switch is based on a Layer (L1) signaling or L2 signaling.

In one embodiment, the L1 signaling comprises Downlink Control Information (DCI).

In one embodiment, the L2 signaling comprises a MAC CE.

In one embodiment, the non-L3 cell switch is beam level mobility.

In one embodiment, the non-L3 cell switch occurs within a cell.

In one embodiment, the non-L3 cell switch occurs between cells.

In one embodiment, when assessing the radio link quality yields a result of out-of-sync, non-L3 cell switch is triggered.

In one embodiment, when there occurs radio link failure, non-L3 cell switch is triggered.

In one embodiment, when beam failure is detected, non-L3 cell switch is triggered.

### Embodiment 7

Embodiment 7 illustrates a schematic diagram of first time according to one embodiment of the present application, as shown in FIG. 7. In FIG. 7, each rectangle filled with oblique lines represents an SSB, where each of arrows j1, j2 and j3 respectively indicates a piece of time. What should be noted is that the width of each rectangle in the figure does not imply the size of time occupied in time domain.

In Embodiment 7, the third signaling is used to determine first time; for at least one reference signal resource in the second reference signal resource group. EPRE before the first time and after the first time cannot be deemed constant.

In one embodiment, the third signaling is UE-specific.

In one embodiment, the third signaling is UE group specific.

In one embodiment, the third signaling is cell-specific.

In one embodiment, the third signaling is specific to the first serving cell.

In one embodiment, the third signaling is a MAC CE.

In one embodiment, the third signaling is a DCI.

In one embodiment, a format of the DCI includes DCI 2_0.

In one embodiment, a format of the DCI includes DCI 2_1.

In one embodiment, a format of the DCI includes DCI 2_2.

In one embodiment, a format of the DCI includes DCI 2_3.

In one embodiment, a format of the DCI includes DCI 2_6.

In one embodiment, the first time is one of j1, j2 or j3.

In one embodiment, the first time is j1.

In one embodiment, the first time is j1, where EPRE after j1 cannot be assumed to be identical to EPRE before j1.

In one embodiment, the first time is j1, where EPRE after j1 is deemed to have increased.

In one embodiment, the first time is j1, where time of receiving the third signaling is before j1.

In one embodiment, the first time is j2.

In one embodiment, the first time is j2, where EPRE after j2 cannot be assumed to be identical to EPRE before j2.

In one embodiment, the first time is j2, where EPRE after j2 is deemed to have decreased.

In one embodiment, the first time is j2, where time of receiving the third signaling is between j1 and j2.

In one embodiment, the first time is j3.

In one embodiment, the first time is j3, where EPRE after j3 cannot be assumed to be identical to EPRE before j3.

In one embodiment, the first time is j3, where EPRE after j3 is deemed to have decreased.

In one embodiment, the first time is j3, where time of receiving the third signaling is between j2 and j3.

In one embodiment, EPRE is deemed constant within a period of time between j1 and j2.

In one embodiment, EPRE is deemed constant within a period of time between j2 and j3.

In one embodiment, the first time is a slot.

In one embodiment, the first time is a start time of a slot.

In one embodiment, the first time is a multicarrier symbol.

In one embodiment, the first time is a start time of a multicarrier symbol.

In one embodiment, the multicarrier symbol is an Orthogonal Frequency Division Multiplexing (OFDM) Symbol.

In one embodiment, the multicarrier symbol is a Single-Carrier Frequency Division Multiple Access (SC-FDMA) symbol.

In one embodiment, the multicarrier symbol is a Discrete Fourier Transform Spread Orthogonal Frequency Division Multiplexing (DFT-S-OFDM) symbol.

In one embodiment, the multicarrier symbol is an Interleaved Frequency Division Multiple Access (IFDMA) symbol.

In one embodiment, the multicarrier symbol comprises a Cyclic Prefix (CP).

In one embodiment, the first time is an OFDM symbol.

In one embodiment, the first time is a start time of an OFDM symbol.

In one embodiment, the first time is after M consecutive OFDM symbols from a first instance of time.

In one embodiment, M is an integer.

In one embodiment, M is a non-negative integer.

In one embodiment, M is a positive integer.

In one embodiment, the first instance of time is an end time of a last OFDM symbol occupied by the third signaling.

In one embodiment, the first instance of time is an end time of a slot occupied by the third signaling.

In one embodiment, the first time is after N consecutive slots from the first instance of time.

In one embodiment, N is an integer.

In one embodiment, N is a non-negative integer.

In one embodiment, N is a positive integer.

In one embodiment, a time interval between the first time and the first instance of time is no smaller than 5 ms.

In one embodiment, a time interval between the first time and the first instance of time is equal to 5 ms.

In one embodiment, a time interval between the first time and the first instance of time is no smaller than 10 ms.

In one embodiment, a time interval between the first time and the first instance of time is equal to 10 ms.

In one embodiment, the first time is configurable.

In one embodiment, the first time is pre-configured.

In one embodiment, for at least one reference signal resource in the second reference signal resource group.

EPRE after the first time is deemed to have decreased.

In one embodiment, for at least one reference signal resource in the second reference signal resource group. EPRE after the first time is deemed to have increased.

### Embodiment 8

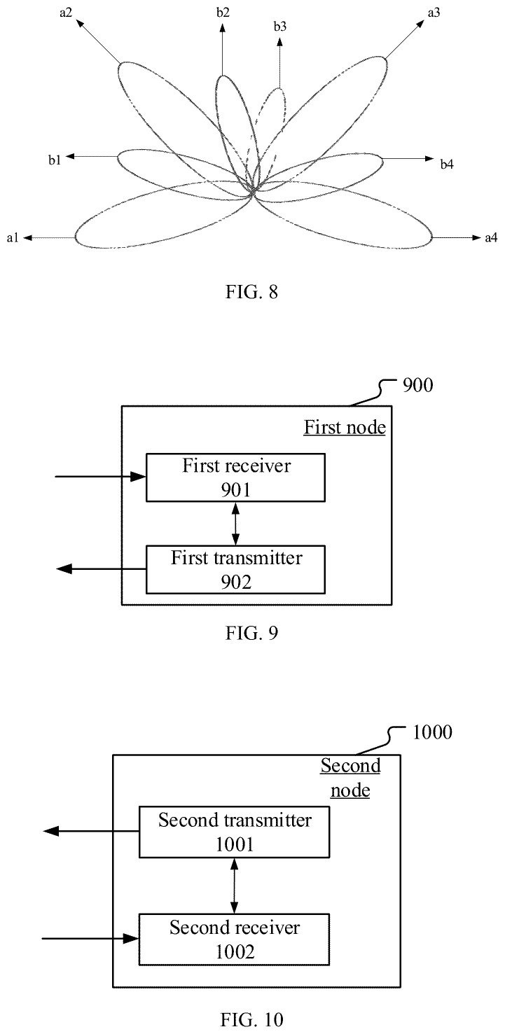

Embodiment 8 illustrates a schematic diagram illustrating beams of a first reference signal resource group and a second reference signal resource group according to one embodiment of the present application, as shown in FIG. 8. In FIG. 8, each ellipse represents a beam.

In one embodiment, beam a1, beam a2, beam a3 and beam a4 belong to the first reference signal resource group.

In one embodiment, beam b1, beam b2, beam b3 and beam b4 belong to the second reference signal resource group.

In one embodiment, EPREs of beams belonging to the first reference signal resource group are deemed constant.

In one embodiment, EPREs of beams belonging to the second reference signal resource group cannot be deemed constant.

In one embodiment, EPRE of beam a1 is deemed constant.

In one embodiment, EPRE of beam a2 is deemed constant.

In one embodiment, EPRE of beam a3 is deemed constant.

In one embodiment, EPRE of beam a4 is deemed constant.

In one embodiment, EPREs of any two beams among the beam a1, the beam a2, the beam a3 and the beam a4 are deemed identical.

In one embodiment, EPREs of all beams among the beam a1, the beam a2, the beam a3 and the beam a4 are deemed identical.

In one embodiment, EPRE of beam b1 cannot be deemed constant.

In one embodiment, EPRE of beam b2 cannot be deemed constant.

In one embodiment, EPRE of beam b3 cannot be deemed constant.

In one embodiment, EPRE of beam b4 cannot be deemed constant.

In one embodiment, EPREs of any two beams among the beam b1, the beam b2, the beam b3 and the beam b4 cannot be deemed identical.

In one embodiment, EPREs of any two beams among the beam b1, the beam b2, the beam b3 and the beam b4 are deemed identical.

### Embodiment 9

Embodiment 9 illustrates a structure block diagram of a processing device in a first node according to one embodiment of the present application, as shown in FIG. 9.

In FIG. 9, a first node's processing device 900 comprises a first receiver 901 and a first transmitter 902, the first node 900 is a UE.

In Embodiment 9, the first receiver 901 performs a first-type measurement on a first reference signal resource group of a first serving cell; and performs a second-type measurement on a second reference signal resource group of the first serving cell, where each of the first reference signal resource group and the second reference signal resource group respectively comprises at least one reference signal resource, of the at least one reference signal resource each reference signal resource being indicated by an SSB-Index; herein. Energy per resource element (EPRE) in the first reference signal resource group is constant, and EPRE in the second reference signal resource group cannot be assumed to be identical to the EPRE in the first reference signal resource group; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

In one embodiment, the first receiver 901 receives a first signaling; herein, the first signaling comprises an ssb-PositionsInBurst, where all reference signal resources indicated by SSB-indexes corresponding to bits with a value of 1 in the ssb-PositionsInBurst in the first signaling form the first reference signal resource group.

In one embodiment, the first receiver 901 receives a second signaling; herein, the second signaling indicates an SSB-index of each reference signal resource in the second reference signal resource group.

In one embodiment, the first-type measurement and the second-type measurement are respectively used for assessing the radio link quality and Non-L3 Cell Switch.

In one embodiment, the candidate purpose set comprises radio link monitoring.

In one embodiment, the first transmitter 902 transmits a first CSI report; herein, the first CSI report depends on the second-type measurement.

In one embodiment, the first receiver 901 receives a third signaling; herein, the third signaling is used to determine first time; for at least one reference signal resource in the second reference signal resource group. EPRE before the first time and after the first time cannot be deemed constant.

In one embodiment, the first receiver 901 comprises the antenna 452, the receiver 454, the multi-antenna receiving processor 458, the receiving processor 456, the controller/processor 459, the memory 460 and the data source 467 in FIG. 4 of the present application.

In one embodiment, the first receiver 901 comprises the antenna 452, the receiver 454, the multi-antenna receiving processor 458 and the receiving processor 456 in FIG. 4 of the present application.

In one embodiment, the first receiver 901 comprises the antenna 452, the receiver 454 and the receiving processor 456 in FIG. 4 of the present application.

In one embodiment, the first transmitter 902 comprises the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 902 comprises the antenna 452, the transmitter 454, the multi-antenna transmitting processor 457 and the transmitting processor 468 in FIG. 4 of the present application.

In one embodiment, the first transmitter 902 comprises the antenna 452, the transmitter 454 and the transmitting processor 468 in FIG. 4 of the present application.

### Embodiment 10

Embodiment 10 illustrates a structure block diagram of a processing device in a second node according to one embodiment of the present application, as shown in FIG. 10. In FIG. 10, a second node's processing device 1000 comprises a second transmitter 1001 and a second receiver 1002; the second node 1000 is a base station.

In Embodiment 10, the second transmitter 1001 transmits a reference signal on a first reference signal resource group of a first serving cell, the first reference signal resource group being used for performing a first-type measurement; and transmits a reference signal on a second reference signal resource group of the first serving cell, the second reference signal resource group being used for performing a second-type measurement; where each of the first reference signal resource group and the second reference signal resource group respectively comprises at least one reference signal resource, of the at least one reference signal resource each reference signal resource being indicated by an SSB-Index; herein, EPRE in the first reference signal resource group is constant, while EPRE in the second reference signal resource group is variable; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

In one embodiment, the second transmitter 1001 transmits a first signaling; herein, the first signaling comprises an ssb-PositionsInBurst, where all reference signal resources indicated by SSB-indexes corresponding to bits with a value of 1 in the ssb-PositionsInBurst in the first signaling form the first reference signal resource group.

In one embodiment, the second transmitter 1001 transmits a second signaling; herein, the second signaling indicates an SSB-index of each reference signal resource in the second reference signal resource group.

In one embodiment, the first-type measurement and the second-type measurement are respectively used for assessing the radio link quality and Non-L3 Cell Switch.

In one embodiment, the candidate purpose set comprises radio link monitoring.

In one embodiment, the second receiver 1002 receives a first CSI report; herein, the first CSI report depends on the second-type measurement.

In one embodiment, the second transmitter 1001 transmits a third signaling; herein, the third signaling is used to determine first time; for at least one reference signal resource in the second reference signal resource group. EPRE before the first time and after the first time is variable.

In one embodiment, the second transmitter 1001 comprises the antenna 420, the transmitter 418, the multi-antenna transmitting processor 471, the transmitting processor 416, the controller/processor 475 and the memory 476 in FIG. 4 of the present application.

In one embodiment, the second transmitter 1001 comprises the antenna 420, the transmitter 418, the multi-antenna transmitting processor 471 and the transmitting processor 416 in FIG. 4 of the present application.

In one embodiment, the second transmitter 1001 comprises the antenna 420, the transmitter 418 and the transmitting processor 416 in FIG. 4 of the present application.

In one embodiment, the second receiver 1002 comprises the antenna 420, the receiver 418, the multi-antenna receiving processor 472, the receiving processor 470, the controller/processor 475 and the memory 476 in FIG. 4 of the present application.

In one embodiment, the second receiver 1002 comprises the antenna 420, the receiver 418, the multi-antenna receiving processor 472 and the receiving processor 470 in FIG. 4 of the present application.

In one embodiment, the second receiver 1002 comprises the antenna 420, the receiver 418 and the receiving processor 470 in FIG. 4 of the present application.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT). RFID terminals. NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B). Transmitter Receiver Point (TRP), and other radio communication equipment.

The above are merely the preferred embodiments of the present application and are not intended to limit the scope of protection of the present application. Any change or modification made based on the embodiments described in this specification, if, through which similar partial or all technical effects can be obtained, shall be considered apparent and fall within the scope of protection of the present invention.

What is claimed is:

1. A first node for wireless communications, characterized in comprising:
a first receiver, performing a first-type measurement on a first reference signal resource group of a first serving cell; and performing a second-type measurement on a second reference signal resource group of the first serving cell, where each of the first reference signal resource group and the second reference signal resource group respectively comprises at least one reference signal resource, of the at least one reference signal resource each reference signal resource being indicated by an SSB-Index;
wherein Energy per resource element (EPRE) in the first reference signal resource group is constant, and EPRE in the second reference signal resource group cannot be assumed to be identical to the EPRE in the first reference signal resource group; of the first-type measurement and the second-type measurement only the first-type measurement is used for a first purpose, the first purpose being any purpose in a candidate purpose set; the candidate purpose set comprises at least one of Cell Search or Layer3 (L3) Cell Handover.

2. The first node according to claim 1, characterized in comprising:
the first receiver, receiving a first signaling;
wherein the first signaling comprises an ssb-PositionsInBurst, where all reference signal resources indicated by SSB-indexes corresponding to bits with a value of 1 in the ssb-PositionsInBurst in the first signaling form the first reference signal resource group.

3. The first node according to claim 1, characterized in comprising:
the first receiver, receiving a second signaling;
wherein the second signaling indicates an SSB-index of each reference signal resource in the second reference signal resource group.

4. The first node according to claim 1, characterized in that the first-type measurement and the second-type measurement are respectively used for assessing the radio link quality and Non-L3 Cell Switch.

5. The first node according to claim 4, characterized in that the candidate purpose set comprises radio link monitoring.

6. The first node according to claim 1, characterized in comprising:
a first transmitter, transmitting a first Channel State Information (CSI) report;
wherein the first CSI report depends on the second-type measurement.

7. The first node according to claim 1, characterized in comprising:
the first receiver, receiving a third signaling;
wherein the third signaling is used to determine first time; for at least one reference signal resource in the second reference signal resource group, EPRE before the first time and after the first time cannot be deemed constant.

8. A second node for wireless communications, characterized in comprising:
a second transmitter, transmitting a reference signal on a first reference signal resource group of a first serving cell, the first reference signal resource group being used for performing a first-type measurement; and transmitting a reference signal on a second reference signal resource group of the first serving cell, the second reference signal resource group being used for performing a second-type measurement; where each of the first reference signal resource group and the second reference signal resource group respectively comprises at least one reference signal resource, of the at least one reference signal resource each reference signal resource being indicated by an SSB-Index;
wherein EPRE in the first reference signal resource group is constant, while EPRE in the second reference signal resource group is variable; of the first-type measurement and the second-type measurement only the first-type measurement is used for a first purpose, the first purpose being any purpose in a candidate purpose set; the candidate purpose set comprises at least one of Cell Search or L3 Cell Handover.

9. The second node according to claim 8, characterized in comprising:
the second transmitter, transmitting a first signaling;
wherein the first signaling comprises an ssb-PositionsInBurst, where all reference signal resources indicated by SSB-indexes corresponding to bits with a value of 1 in the ssb-PositionsInBurst in the first signaling form the first reference signal resource group.

10. The second node according to claim 8, characterized in comprising:
the second transmitter, transmitting a second signaling;
wherein the second signaling indicates an SSB-index of each reference signal resource in the second reference signal resource group.

11. The second node according to claim 8, characterized in that the first-type measurement and the second-type measurement are respectively used for assessing the radio link quality and Non-L3 Cell Switch.

12. The second node according to claim 8, characterized in comprising:
a second receiver, receiving a first CSI report;
wherein the first CSI report depends on the second-type measurement.

13. The second node according to claim 8, characterized in comprising:
the second transmitter, transmitting a third signaling;
wherein the third signaling is used to determine first time; for at least one reference signal resource in the second reference signal resource group, EPRE before the first time and after the first time cannot be deemed constant.

14. A method in a first node for wireless communications, characterized in comprising:
performing a first-type measurement on a first reference signal resource group of a first serving cell; and performing a second-type measurement on a second reference signal resource group of the first serving cell, where each of the first reference signal resource group and the second reference signal resource group respectively comprises at least one reference signal resource, of the at least one reference signal resource each reference signal resource being indicated by an SSB-Index;
wherein EPRE in the first reference signal resource group is constant, and EPRE in the second reference signal resource group cannot be assumed to be identical to the EPRE in the first reference signal resource group; of the first-type measurement and the second-type measurement only the first-type measurement is used for a first purpose, the first purpose being any purpose in a candidate purpose set; the candidate purpose set comprises at least one of Cell Search or L3 Cell Handover.

15. The method in the first node according to claim 14, characterized in comprising:
receiving a first signaling;
wherein the first signaling comprises an ssb-PositionsInBurst, where all reference signal resources indicated by SSB-indexes corresponding to bits with a value of 1 in the ssb-PositionsInBurst in the first signaling form the first reference signal resource group.

16. The method in the first node according to claim 14, characterized in comprising:
receiving a second signaling;
wherein the second signaling indicates an SSB-index of each reference signal resource in the second reference signal resource group.

17. The method in the first node according to claim 14, characterized in that the first-type measurement and the second-type measurement are respectively used for assessing the radio link quality and Non-L3 Cell Switch.

18. The method in the first node according to claim 17, characterized in that the candidate purpose set comprises radio link monitoring.

19. The method in the first node according to claim 14, characterized in comprising:
transmitting a first CSI report;
wherein the first CSI report depends on the second-type measurement.

20. The method in the first node according to claim 14, characterized in comprising:
receiving a third signaling;
wherein the third signaling is used to determine first time; for at least one reference signal resource in the second reference signal resource group, EPRE before the first time and after the first time cannot be deemed constant.
